(19) United States
(12) Patent Application Publication
(10) Pub. No.: US 2016/0316792 A1
(43) Pub. Date: Nov. 3, 2016

(54) TOPICAL CRUST COLORANT

(71) Applicant: RHODES INTERNATIONAL, INC., Murray, UT (US)

(72) Inventor: John SCHNEIDER, Horicon, WI (US)

(21) Appl. No.: 14/701,419

(22) Filed: Apr. 30, 2015

(51) Int. Cl. A23L 1/275; A21D 8/02

(52) U.S. Cl. CPC A23L 1/2756; A21D 8/02; A23V 2002/00

(57) ABSTRACT

A powdered crust colorant for topical application to a white dough is prepared from dextrose, wheat starch, pregelatinized starch and powdered caramel colorant. The colorant is applied topically to the exterior surface of the white dough after it has been formed into a cinnamon roll. The white dough with the powdered crust colorant is then frozen and later placed in a microwave so that upon finishing the white dough into a cinnamon roll, the crust colorant is heated and causes the top part of the crust to turn brown or tan.

### BACKGROUND OF THE INVENTION

1. The Field

This application relates to the field of baking and more particularly to the preparation of baked products like bread and rolls made from a light or white flour based dough and finished in a microwave and even more particularly to the application of a topical crust colorant to the surface of a frozen cinnamon roll which is later finished in a microwave.

2. The Relevant Technology

The preparation of bread and pastry products for consumption has evolved into what can be viewed as the art and science of baking. Typically, a dough is prepared and then placed in a gas or electric oven to bake for a selected period of time at a desired temperature.

Of course in the process of baking breads and pastries made with certain flours that are light in color in a gas or electric oven, the external surface of such breads and pastries typically develop a crust that turns to a desired color. The quality of such finished breads and pastries are often judged based on the color. In other words, a bread or pastry product made with a light colored flour leading to a light or off-white colored dough that has been over baked in a gas or electric oven has a crust that is a dark brown or dark color. In turn the crust is believed to be too crisp and not tasty; and the bread or pastry is believed to have a dry or over done and/or dry interior. A tan or medium brown color is often associated with a preferred product that is baked correctly and will have a desired tasty crust and a preferred properly done and tasty and/or soft interior. A very light tan or even lighter in color is typically associated with an underdone (not baked/cooked long enough) bread or pastry product which will be chewy and even excessively moist and in turn not tasty.

With the advent of the microwave oven, a variety of foods have been devised or created that are specifically tailored for final preparation in or using a microwave oven. For example, frozen dinners and frozen vegetables are now widely known and widely used which are prepared for cooking in a microwave. While the microwave device may be called an oven, a microwave does not heat the air in the interior as in a gas or electric oven but rather interacts with the molecules of whatever the object to be heated is in the microwave generating heat which is transferred to other molecules to heat the entire object. Such frozen food is typically placed in the microwave in a frozen state and is removed a few minutes later thawed, heated and ready to eat.

Some frozen bread and pastry products have been devised and are typically intended for baking in a gas oven and/or an electric oven following procedures that allow the bread dough and pastry dough to rise or proof. After thawing and rising, such breads and pastries are baked in a gas and/or electric oven for a notable period of time which may exceed for example, 15 minutes. The time involved to prepare includes thawing time plus preparation and baking can delay or deter use of the product.

The use of a microwave oven to bake dough products is known. U.S. Pat. No. 6,579,546 (Jahnke) disclosed a method of making a microwavable bakery product that is first thawed and then proofed before it is baked in a microwave. U.S. Pat. No. 6,468,569 (Dunker and Wendland) discloses a pastry product that also is first thawed and proofed before it is prepared in an oven.

Applicant believes that dough products prepared using a light colored flour and baked in a microwave will have a light or white-like color that suggests they are not optimally prepared or underdone. That is, the product may be successfully prepared, but the result is not believed to be optimal because the color suggests the product is not optimal.

There is a need for a process or way to color breads and pastries made from a light colored dough and more particularly to color the crust of such breads and pastries which are then prepared in a microwave so that the breads and pastries have the appearance of breads and pastries properly and correctly baked in a gas and/or electric oven.

### BRIEF SUMMARY

A crust colorant is prepared for topical application to a dough product so that when the dough product is baked or finished, it has the color as if it were baked in a gas or electric oven. The dough is made from a white or light colored flour and formed into a product. It may then be frozen after which the crust colorant is applied; or it may be frozen after application of the crust colorant. With the crust colorant applied, the frozen dough is finished in an oven (gas, electric or microwave) directly from the frozen state to produce a product colored to a finished state and available for consumption.

A crust colorant is made by combining sugar, a carbohydrate starch, pregelatinized starch, and a powdered colorant. Preferably, the colorant is the combination from about 80 to about 110 baker's percent of a sugar such as dextrose, from about 30 to about 50 baker's percent of a carbohydrate starch such as wheat starch, from about 3 to about 5 baker's percent of a pregelatinized starch, and from about 5 to about 8 baker's percent of a powdered color such as a powdered caramel color.

The sugar used is preferably a powdered sugar and may be dextrose.

The carbohydrate starch is preferably wheat starch; and the powdered colorant is preferably powdered caramel colorant.

The term “baker's percent” is used in commercial baking in which all ingredients of a particular recipe are measured relative to the flour found in the main dough formula. Thus, the ingredients of a theoretical product that is formed from yeast, flour, butter and salt would all be measured in relation to the flour. If a batch were to be made using 100 pounds of flour, and 1 pound of yeast, then the yeast would be 1 baker's percent. If the recipe used 4 pounds of butter, then it would be 4 baker's percent. Similarly, if the recipe included ½ pound of salt, that would be 0.5 baker's percent. Thus the total ingredients would be

Flour 100

Yeast 1

Butter 4

Salt 0.5

Total 105.5 Baker's percent.

Even when preparing icing or frosting and any other coatings, all ingredients are measured relative to the flour found in the main product.

In an alternate arrangement scaled down in volume or weight, the crust colorant is assembled or prepared using about 88.889 baker's percent of dextrose, about 35.556 baker's percent of wheat starch, about 3.556 baker's percent of pregelatinized starch, and about 6 percent of powdered caramel color.

A method of making a crust colorant is also disclosed in which: from about 80 to about 110 baker's percent and preferably 100 baker's percent of a sugar such as dextrose is measured or metered and then placed in the bowl of a mixer. Then about 30 to about 50 baker's percent and preferably about 40 baker's percent of a carbohydrate starch such as wheat starch, from about 3 to about 5 baker's percent and preferably about 4 baker's percent of a pregelatinized starch, from about 5 to about 8 baker's percent and preferably about 6.75 baker's percent of a powdered color such as a powdered caramel color are all added to the bowl of a mixer. The mixer may be any suitable machine such as a HOBART® mixer HL 1400 having a 140 quart bowl. The mixer turns a paddle which extends into the bowl and which is operated at a slow speed. While the speed can vary from machine to machine, the slow speed on the HL 1400 is believed to be about 43 RPM. The colorant may then be applied to an unfinished dough or to an unfinished frozen dough by any suitable application device or placed in suitable containers for storage.

The unfinished dough with the colorant applied may then be packaged in a frozen state in a suitably sized package. To prepare the frozen dough product for consumption, the frozen dough product with the colorant applied is removed from its package in a frozen state and is placed while frozen in a suitable oven where it is finished. It is here contemplated that the oven is a microwave oven. The microwave may be operated preferably at full power for a period of about 1 minute. At the end of the period, the frozen dough product will have thawed, risen, and baked all the way through. At the same time, the colorant will have melted and coated the surface of the now finished dough product. It is presently contemplated that the unfinished frozen dough product is a frozen cinnamon roll and that the finished dough product is an edible cinnamon roll that has a tan exterior comparable to a cinnamon roll finished in a conventional oven.

### BRIEF DESCRIPTION OF THE DRAWINGS

To further clarify the above and other advantages and features of the present powdered crust colorant, a more particular description of the crust colorant and its method of use will be rendered by reference to the appended drawings. It should be understood that figures depict only typical embodiments and therefore are not to be considered limiting of the scope of the appended claims. In the drawings:

FIG. 1. is a block diagram depicting the steps of the method of making the disclosed colorant, of applying it to a dough product, and the ingredients of the disclosed topical colorant;

FIG. 2 is a simplified illustration of a mixer with a bowl for use in preparing the disclosed crust colorant;

FIG. 3 is a simplified side plan view of a drum applicator with associated powder supply device and transport devices;

FIG. 4 is a simplified partial perspective view of the drum of FIG. 3; and

FIG. 5 is a partial cross sectional view of a portion of the drum of FIG. 3 and FIG. 4.

### DESCRIPTION

A wide variety of baked goods are prepared from a dough that is itself assembled or prepared using flour that is light in color or white in color. Depending on the other ingredients added, such dough is typically not white but off white in color and is herein referred to as white dough. All references herein to white dough are intended to refer to the off-white, light greyish or light eggshell colored dough that has white flour as its main or significant ingredient unless specifically stated otherwise.

Depending on the ingredients, the white dough can be processed through various steps including kneading, proofing (rising) and baking. When baking occurs in a traditional gas or electric oven at selected temperatures for a selected time, the resulting product has a desired texture and color. That is, breads and rolls made from a white dough typically form a crust that is tan or light brown in color when the interior at about the same time has attained the desired texture or consistency so that it is regarded as done. The baking process can also be referred to as “finishing” in that the white dough has been formed into product before it is baked and in turn finished.

Some white dough can be made into a desired bakery product and then frozen before proofing and baking. To use or prepare that desired bakery product, the user removes it from the freezer and then follows steps or instructions which involve placing the frozen dough in a place where the desired bakery product can thaw and then rise. After achieving a certain size, the now thawed and risen desired bakery product is placed into a gas oven or electric oven for baking at a desired temperature for a desired period of time. In some cases, white dough products are done even though they have not yet attained a desired crust color.

Some frozen white dough bakery products have been devised for baking in a microwave. Presently it is understood they are taken from a freezer and then allowed to proof or rise before they are placed in a microwave for baking. Recently a white dough has been devised which can be made into a variety of desired bakery products one of which is a cinnamon roll. The white dough product is frozen before proofing and baking; and thereafter it can be placed directly into a microwave in a frozen state and baked until it is done. While done, it has a whitish color and does not appear to have the coloring of a traditional or typical cinnamon roll found in a pastry shop or bakery or prepared by other traditional means.

A crust colorant is here disclosed which can be applied to the white dough bakery product before it is frozen. Thus a white dough bakery product that is frozen and that is thereafter proofed and baked in a traditional gas or electric oven but does not attain the desired color may be topically coated with the crust colorant before it is frozen to present a color when done that is consistent with normal baking. Similarly, a white dough bakery product that is frozen can be topically coated with the crust colorant before it is frozen. Upon placement in a microwave and baking it, the white dough bakery product placed in a microwave for baking will attain the desired coloration of being done when it is in fact done. Thus a white dough bakery product like a cinnamon roll will attain a desired tan coloration at the same time that it is done and has an acceptable consistency.

The crust colorant disclosed is comprised of a sugar, a carbohydrate starch, a wheat starch, a pregelatinized starch and a colorant. The resulting crust colorant is a powder that is suitable for topical application by any suitable method including brushing, sprinkling by hand, sprinkling with a hand device and drum coating. The crust colorant is thus attached as a powder on or to the surface of a white dough product.

As noted, the crust colorant has about 80 to about 110 baker's percent of a sugar and preferably is 100 baker's percent. As noted hereinbefore, the term baker's percent is that amount of or a percentage relative to the flour used in the white dough to be coated. Thus the total portions will total something that may be greater or less than 100%. Further the exact weight of material to be used (in pounds or grams) will vary based on the weight of the flour in the white dough. In turn the quantity of crust colorant made is proportioned for the product to be coated with the crust colorant.

The preferred sugar is crystalline dextrose. However suitable alternatives include white extra fine sugar, fruit sugar, baker's special sugar, confectioner's or powdered sugar, free flowing brown sugar and similar fine crystalline sugars. Even dried syrup powders can be used.

The carbohydrate starch included in the crust colorant is preferably about 30 to about 50 baker's percent of a wheat starch and most preferably 40 baker's percent. The carbohydrate starch functions as a thickener, stabilizer and ingredient carrier. Alternates to the wheat starch include food grade corn starch, tapioca starches, potato starches, rice starches as well as modified wheat starch.

The crust colorant includes from about 3 to about 5 baker's percent of a pregelatinized starch and preferably about 4 baker's percent. A starch is pregelatinized when it is cooked and then dried in a drum dryer or in an extruder. Thus it is water soluble and even soluble in cold water; and when the starch is placed in and or is otherwise in the presence of water, it in effect creates a gelatin.

In the crust colorant disclosed alternative pregelatinized starches include pregelatinized corn starch, pregelatinized tapioca starches, pregelatinized potato starches, pregelatinized arrowroot starches and pregelatinized waxy maize starches. Other substances that function as a pregelatinized material would most likely be suitable so long as the resulting topical crust colorant is suitable for application to the surface of an unfinished or unbaked white dough.

The crust colorant includes from about 5 to about 8 baker's percent of a powdered color and preferably 6.75 baker's percent. While a tan or brown color is presently contemplated, some white dough products may be colored differently. That is, one may want to color a product green or red or blue for a particular reason such as for an event or holiday. Other colors like a raspberry color could be desired for a raspberry filled pastry.

In the preferred crust colorant, the powdered color is 6.75 baker's percent of powdered caramel color. Caramel coloring is water soluble and is made by heat treating carbohydrate starches in the presence of an acid, alkali or salt. The process is sometimes referred to as caramelization. The caramel coloring is made to different color intensities which are measurable and called tinctorial power. The tinctorial power is based on a formula where the absorbance of light at a wavelength of about 560 nanometers by 1 milligram of the material in 1 milliliter of water is measured (times 100) and divided by the total solids in solution. The caramel also has a liner hue index which measures the color hue or red characteristics based on the absorbance of light of 510 and 610 nanometers. The caramel coloring is also categorized in standard classes based on how it is prepared.

The preferred caramel coloring is a powder that is in class 1 and which has a tinctorial power of 0.078 to 0.096 and an intensity (ko. 56) from 0.16 to 0.19 (the larger the number the darker the hue). Other suitable powdered caramel colorings include:

| Class | Item | Tinctorial Power | Color Intensity |
|---|---|---|---|
| 1 | Powdered Caramel Color | 0.090-0.140 | 0.044-0.068 |
| 1 | Organic Powdered Carmel | 0.195-0.245 | 0.100-0.130 |
| | Color | | |
| 3 | Powdered Caramel Color | 0.200-0.250 | 0.100-0.128 |
| 3 | Powdered Caramel Color | 0.300-0.350 | 0.170-0.204 |
| 3 | Powdered Caramel Color | 0.300-0.350 | 0.210-0.240 |
| 3 | Powdered Caramel Color | 0.420-0.480 | 0.236-0.279 |

In one example, a white dough is provided that has 89 pounds of white or light flour. A crust colorant for application to the surface of the unfinished or unbaked white dough assembled and separated into products is prepared and comprises:

88.889 baker's percent of dextrose;

35.556 baker's percent of the preferred wheat starch;

3.556 baker's percent of the preferred pregelatinized starch; and

6 percent of the preferred powdered caramel color.

In this example, a single batch can be made wherein the dextrose measures 88.889 pounds, the wheat starch measures 35.556 pounds, the pregelatinized starch measures 3.556 pounds and the powdered caramel color measures 6 pounds.

In another example of a more preferred topically applied powder crust colorant, white dough is provided which includes or uses white or light colored flour. The crust colorant is applied to the surface of the unbaked and unfinished products that have been formed from the white dough. The white dough may be frozen before or after the crust colorant is applied. The crust colorant comprises:

100 baker's percent of dextrose;

40 baker's percent of the preferred wheat starch;

4 baker's percent of the preferred pregelatinized starch; and

6.75 percent of the preferred powdered caramel color. In this example, one batch of powder crust colorant can be made wherein the dextrose can be 100 pounds with each other ingredient being the same in pounds.

To prepare the crust colorant, a maker provides and measures the ingredients. Any suitable measuring device like a scale will be sufficient. The user obtains or provides each of the ingredients and then measures them to meet the desired baker's percent by weighing them. Thus, for a white dough that includes or is made with white or light colored flour, one measures on a suitable measuring device like a scale the amounts identified in the two examples. These measured or metered amounts are then put into the mixing bowl of a suitable mixer like a Hobart Model HL 1400 having a 140 quart mixing bowl and a 5 horse power motor with 5 stir speeds. A flat beater agitator is used which is rotated at the same rate (revolutions per minute) as the motor when connected. That is, the flat paddle agitator is connected to the motor drive to extend into the 140 quart mixing bowl.

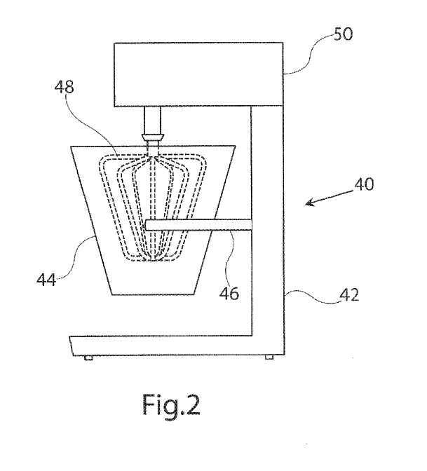

FIG. 2 is a simplified illustration of a suitable mixer 40 like the Hobart HL 1400. The mixer 40 that has a frame and housing 42 with a bowl 44 held by a pair of support arms (only one visible) 46. A paddle agitator 48 is shown extending into the bowl 44 which is driven or rotated by a motor located in the upper housing 50.

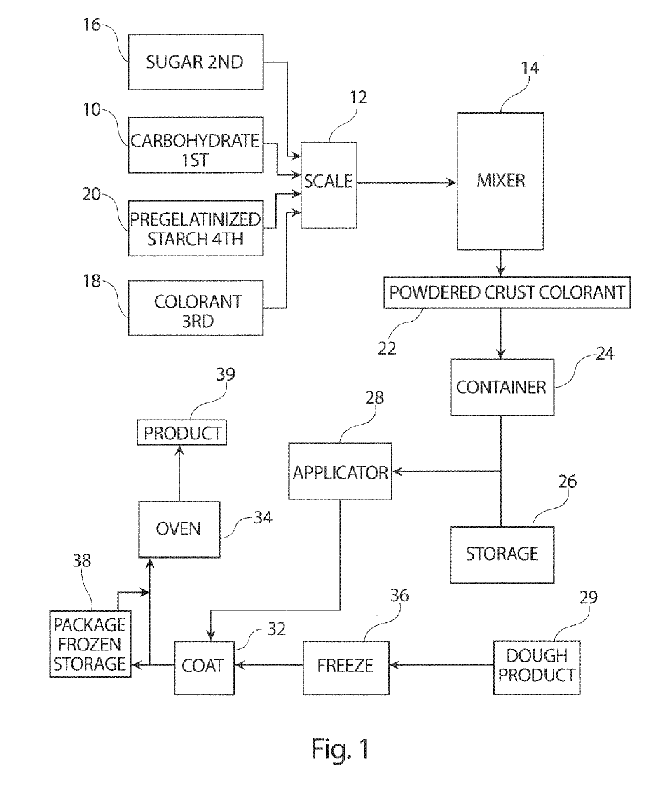

When the 140 quart mixing bowl 44 is positioned on the mixer 40, and the flat paddle agitator 48 is attached to the mixer to extend into the bowl 44, the ingredients are measured and placed into the bowl. Preferably the carbohydrate 10 (FIG. 1) like the wheat starch is placed in the mixer 14 and more specifically the 140 quart mixing bowl 48 (FIG. 2) first. The next or second ingredient is the sugar 16 such as dextrose. Thereafter the colorant 18 such as a powdered caramel colorant is added third followed by the last or fourth ingredient which is the pregelatinized starch 20.

After all the ingredients are scaled 12 and then added to the 140 quart mixing bowl 48 (FIG. 2), the mixer 40 is operated at its slow speed of 46 revolutions per minute (RPM). In turn, the paddle agitator 48 rotates at 46 RPM. The mixer 40 is operated for 10 minutes after which it is turned off. The contents are now the powdered crust colorant which is ready for application to the surface of a white dough and more specifically to the separate products formed of the white dough. The powdered crust colorant 22 (FIG. 1) may be applied before or after freezing the dough. Alternately, the powdered crust colorant is placed into one or more suitably sized containers and sealed; and thereafter the sealed containers are placed in storage. While in storage, the containers must remain sealed and the powder crust colorant must be maintained dry.

While it is stated that the metered or measured ingredients 10, 16, 18 and 20 are each placed in the bowl of the mixer 14 immediately after measuring or metering on, for example, a scale 12, the ingredients 10, 16, 18 and 20 may be placed in separate containers and added in the correct sequence later. Similarly, the sequence of adding the ingredients is as stated; but those skilled in the art will recognize that other sequences may be used.

After all the ingredients 10, 16, 18 and 20 are in the bowl, the mixer 14 such as the mixer 40 depicted in FIG. 2, is then operated at slow speed of 46 RPM for 10 minutes to create or form a powdered mixture that is the desired powdered crust colorant 22. Thereafter, the powdered crust colorant is either used immediately or placed in a suitable sealed container which is preferably a corrugated cardboard carton with a polyethylene inner bag that can be and is sealed. Other suitable sealable containers may be used of any type or size so long as they allow for dry sealed storage. A 50 pound multiwall paper bag is contemplated. In large production arrangements, the cardboard carton is sized to receive 50 pounds of powdered crust colorant. The cartons may be palletized with 16 cartons per layer with three layers per carton.

After filling, the container 24 may be placed in storage 26 or taken to a product production area. The storage 26 is preferably a relatively cool, dry location where the temperature is maintained at or below about 90 degrees Fahrenheit and is preferably maintained about 60-70 degrees Fahrenheit. While there is no cure time for the powdered crust colorant and no actual limit on shelf life, good practice suggests that the shelf life should be limited to about 1 year. Thus production runs of the powdered crust colorant can be prepared well in advance.

When white dough is prepared that needs colorant added topically, the powdered crust colorant 22 as prepared in FIG. 1 can be moved in the container 24 directly from production or from storage 26 to a production site where it can be applied by an applicator 28 to the white dough product 29 in any suitable manner. The powdered crust colorant 22 may be applied with an applicator 28 which may be a sifter (like a flour sifter) or preferably in a rotating drum arrangement as hereinafter discussed. The powdered crust colorant 22 may even be applied manually by hand.

In FIG. 1, it is seen that the dough product 29 is first frozen 36 by placing it in a freezer. Thereafter, while still frozen, it is transported to the vicinity of the applicator 28 where it is coated 32 with the powdered crust colorant 22. The dough product if not then frozen is frozen. The dough product 29 when coated is thereafter sent to packaging and frozen storage 38 after which it may be shipped and sent to locations where a user may obtain the package of frozen dough products coated with the powdered crust colorant. To prepare or use a frozen dough product coated with the powdered crust colorant, the user removes it from the package and places it in an oven 34 and operates the oven to prepare the product 39 for consumption as hereinafter discussed.

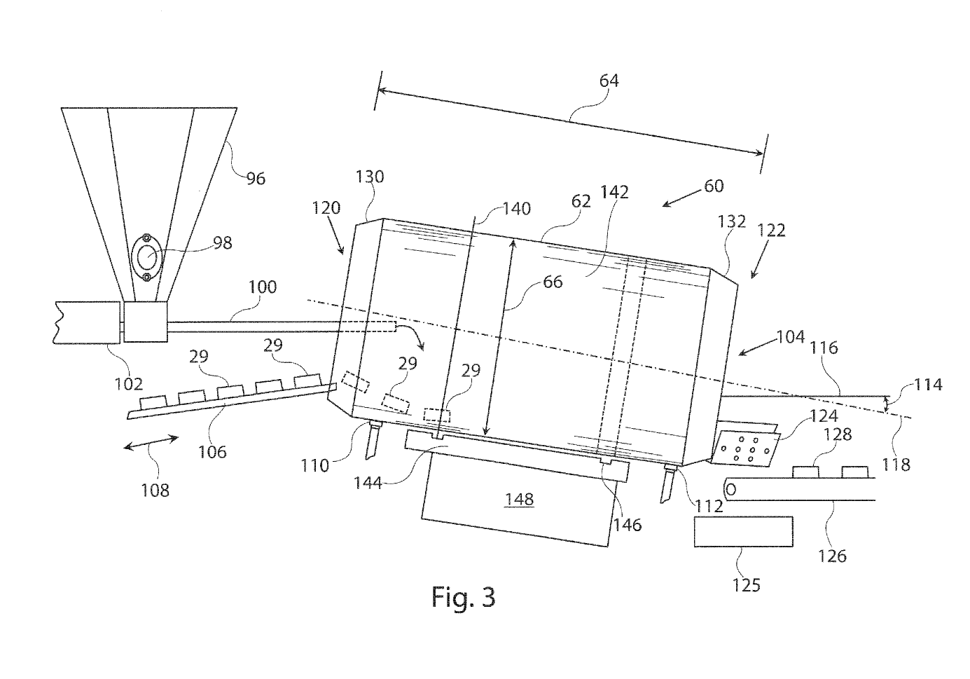

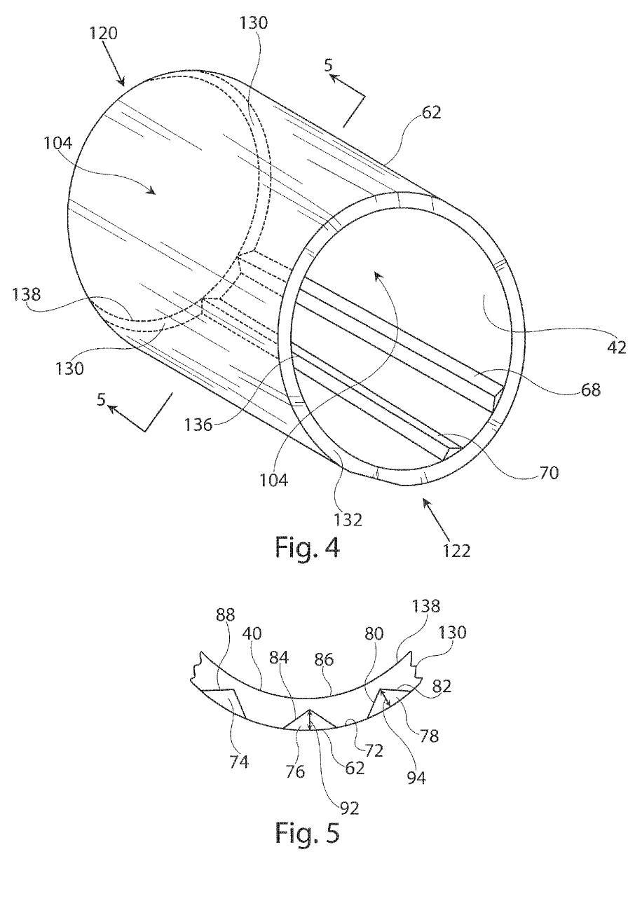

Turning now to FIG. 3, a drum coating system 60 is depicted which has a coating drum 62 what is approximately 48 inches long 64 and approximately 30 inches in diameter 66. The drum is hollow as seen in FIG. 4 with a plurality of spaced baffles about the interior surface 72 of the drum coating drum 62. In FIG. 4, two triangular shaped baffles 68 and 70 are shown for illustration. The other similar shaped baffles around the interior surface 72 are not shown for clarity. As better seen in FIG. 5, the baffles 74, 76 and 78 are shown in cross section to be triangular shaped with the base being the interior surface 72 and two sides 80, 82, 84, 86, 88, and 90. The baffles 74, 76 and 78 have a height 92 that is 1 to 3 inches and preferably about 2 inches. The sides of each baffle such as sides 80 and 82 of baffle 78 are securely joined together such as by welding and from an apex angle which is from about 90 to about 160 degrees and preferably about 150 degrees. In operating, the baffles like baffles 68 and 70 function to lift the contents of the drum 62 up as the drum rotates.

As seen in FIG. 3, the coating system 60 functions as an applicator of the powdered crust colorant 22 which is placed in a hopper 96 which is here shown to be a multisided structure sized to hold at least one container 24 of powdered crust colorant 22. The hopper 96 has a side inspection glass 98 so the operator can see when the level of powdered crust colorant 22 is getting low. The powdered crust colorant 22 is moved by gravity into an auger system inside of a tube 100 that is driven by a motor 102. Thus the powdered crust colorant 22 is moved through the tube 100 and into the interior 104 of the coating drum 62.

As also seen in FIG. 3, individual dough products 29 made from white dough are moved from production and storage on a conveyor 106 into the interior 104 of the coating drum 62. It is preferred that the individual dough products 29 be frozen 36 (FIG. 1) and placed on the conveyor 106 a suitable distance from the coating drum 62 so that the individual dough products 29 are exposed to room temperature long enough to collect a level of moisture or condensation on the exterior surface of each of the individual dough products 29. Thus the length 108 of the conveyor 106 and the speed of the conveyor must be selected to control the time the individual dough products 29 are exposed to the room temperature and also consistent with the time it takes to get the coated individual dough products through packaging and back to frozen storage. In expected commercial production, the individual dough products can be expected to be small with the coating system 60 with related systems operating at rate to produce about 380 products per minute where each piece is about 2 ounces. The powdered crust colorant is applied or used at the rate of about 25 to about 75 pounds per hour. If the individual dough product is a cinnamon roll that is about 2.5 inches in diameter and weighs about 2 ounces, about 0.5 to 1.5 grams of powder crust colorant is applied each cinnamon roll. The coating drum 62 is supported by rollers like rollers 110 and 112 which are all part of a frame structure that allows the user to tilt the coating drum 62 to a desired angle 114 between the horizontal 116 and the axis 118 of the coating drum 62. With the angle 114 selected from about 5 to about 20 degrees and preferably about 10 degrees, individual dough products 29 entering the coating drum 62 at its upper end 120 move in the coating drum 62 with the powdered crust colorant 22 toward the lower end 122. The baffles like baffles 68 and 70 cause the powdered crust colorant 22 and the individual dough products 29 to be urged upward along the interior 72 of the coating drum as it is rotated at a rate of from about 20 to 30 RPM. Thus the powdered crust colorant 22 and the individual dough products 29 move up and fall down tumbling and rotating much like front loading rotating clothes dryers found in many homes. The exterior surface of the individual dough products 29 are now damp because of the time spent in transit on the conveyor 106. In turn the powdered crust colorant 22 sticks to or adheres to the exterior surface of the individual dough products 29 to create coated individual dough products 128 which exit the coating drum 62 at its lower end 122 and fall onto a grate 124 and from the grate 124 onto a discharge conveyor 126. The discharge conveyor 126 transports the coated individual dough products to packaging systems and further freezer storage not shown. A catch container 125 is also shown to catch any powdered crust colorant 22 that comes out of the coating drum 62 and also any which may fall or shake off or fall from coated individual dough products 128. Any powdered crust colorant 22 collected in the catch container 125 may be recycled by depositing it in the hopper 96.

The coating drum 62 as shown in FIGS. 3 and 4 has an angled rim or riser 130 at its upper end 120 and an angled riser 132 at its lower end 122. The risers 130 and 132 function to keep the contents of the coating drum 62 in the interior 104 until the individual dough products 29 are sufficiently coated with powdered crust colorant 22.

As seen in FIG. 3, the coating drum 62 has a guide rim about its exterior 142 which interacts with a guide roller system 144 that also contains stabilizing rollers 146. A control panel is also seen for use by an operator to control the operation of the coating drum 62. The coating drum 62 is driven by variable speed AC motor with a belt drive (not shown).

The coating of the powdered crust colorant is not known exactly but is believed to be about 2 mil in thickness and is in effect a dusting. That is, the powdered crust colorant 22 is applied to the surface of a white dough product such as the individual dough products 29 in sufficient thickness to give the product when baked the desired color. The white dough is made into a white dough product which may be bread, or various rolls. Preferably the white dough product is a cinnamon roll which has been prepared in a suitable manner using a white dough. It is unbaked or unfinished thereby presenting an exterior surface which a user will see when the product is finished or baked. The powdered crust colorant is applied to surface of the dough product 29 so that a user would see a brown normal color when the product is finished to create a coated product 39.

Once a coated product 39 is prepared, it may be placed in a suitable oven 34 for finishing or baking or it may be frozen 32. It is here contemplated that the white dough product or coated product 39 is a cinnamon roll that is frozen 32. After freezing, the coated product 39 or cinnamon roll may be transported in the frozen state to a suitable location where a user may acquire the coated product 39 and thereafter remove it from its package and place it in a suitable oven like oven 34.

While some coated products are intended for baking in a conventional gas or electric oven, the coated product 39 that is frozen is a cinnamon roll 128 as seen in FIG. 3. After being frozen, the unfinished cinnamon roll may be placed in a microwave oven that has an element between 800 and 1600 watts and heated or baked or finished in 60 seconds at full power. The cooking time can vary with altitude and with the power of the microwave. The cooking time can be increased if two or more cinnamon rolls are placed in the microwave. That is, the time to finish may need to be varied based on the power of the microwave and the amount of frozen individual dough product being finished. The frozen coated individual dough product such as the frozen cinnamon roll is understood to be heated or baked by a microwave having about 800 watts power so that the powdered crust colorant will melt as the moisture from the dough product proceeds outwardly and the pregelatinized starch will start to gel to finish the dough and simultaneously produce the desired tan or brown color.

More specifically, the powdered crust colorant 22 prepared in Example one and Example two hereinbefore set forth when placed on a white dough product prepared as a cinnamon roll will produce a desired tan or brown color on the cinnamon roll to make the cinnamon roll more visually appealing to a potential user or consumer. A suitable topping like cream cheese icing may be applied after finishing.

Those skilled in the art will recognize that the disclosed methods may be practiced using materials that may be different from those identified hereinabove without departing from the principles as disclosed. Only specific embodiments have been disclosed to illustrate the compositions and methods as defined by the appended claims.

What is claimed is:

1. A crust colorant comprising:
from about 80 to about 110 baker's percent of a sugar;
from about 30 to about 50 baker's percent of a carbohydrate starch;
from about 3 to about 5 baker's percent of a pregelatinized starch; and
from about 5 to about 8 baker's percent of a powdered color.

2. The crust colorant of claim 1 wherein said sugar is a powdered sugar.

3. The crust colorant of claim 2 wherein the powdered sugar is dextrose.

4. The crust colorant of claim 2 wherein the carbohydrate starch is wheat starch.

5. The crust colorant of claim 2 wherein the carbohydrate starch is unmodified wheat starch.

6. The crust colorant of claim 2 wherein the powdered color is powdered caramel color.

7. A crust colorant comprising:
about 88.889 baker's percent of dextrose;
about 35.556 baker's percent of wheat starch;
about 3.556 baker's percent of pregelatinized starch; and
about 6 percent of powdered caramel color.

8. A crust colorant comprising:
about 100 baker's percent of dextrose;
about 40 baker's percent of wheat starch;
about 4 baker's percent of pregelatinized starch; and
about 6.75 percent of powdered caramel color.

9. A method of making a crust colorant comprising:
providing and measuring from about 80 to about 110 baker's percent of a sugar;
providing and measuring from about 30 to about 50 baker's percent of a carbohydrate starch;
providing and measuring from about 3 to about 5 baker's percent of a pregelatinized starch;
providing and measuring from about 5 to about 8 baker's percent of a powdered colorant;
providing a mixer;
placing said carbohydrate, said sugar, said pregelatinized starch and said powdered colorant into said mixer; and
operating said mixer at a selected speed and for a selected period to mix said sugar, said carbohydrate starch and pregelatinized starch and said powdered colorant to form a crust colorant to color said dough.

10. The method of claim 9 wherein said mixer is a Hobart 140 quart mixer.

11. The method of claim 10 wherein said mixer is operated at a slow speed for a period of about 10 minutes.

12. The method of claim 9 wherein said sugar is powdered sugar.

13. The method of claim 9 wherein said sugar is dextrose.

14. The method of claim 13 wherein said carbohydrate starch is wheat starch.

15. A method of coloring a finished dough, said method comprising:
providing and measuring from about 80 to about 110 baker's percent of a sugar;
providing and measuring from about 30 to about 50 baker's percent of a carbohydrate starch;
providing and measuring from about 3 to about 5 baker's percent of a pregelatinized starch;
providing and measuring from about 5 to about 8 baker's percent of a powdered color;
providing a mixer;
placing said sugar, said carbohydrate starch, said pregelatinized starch and said powdered color into said mixer;
operating said mixer at a selected speed and for a selected time to mix said sugar, said carbohydrate starch, said pregelatinized starch and said powdered color to form a powdered crust colorant;
discharging said powdered crust colorant from said mixture;
providing an unfinished dough;
selectively applying said crust colorant mixture to said unfinished dough and placing said crust colorant mixture into a storage container;
providing an oven; and
finishing said crust colorant mixture and said unfinished dough in said oven for a selected period of time at a selected energy level to form a finished dough with said powdered crust colorant thereon to color said finished dough.

16. The method of claim 15 wherein said sugar is dextrose, wherein said carbohydrate starch is wheat starch, and wherein said powdered colorant is powdered caramel colorant.

17. A method of coloring a finished dough, said method comprising:
providing and measuring about 100 baker's percent of dextrose;
providing and measuring about 40 baker's percent of wheat starch;
providing and measuring about 4 baker's percent of a pregelatinized starch;
providing and measuring about 6.75 baker's percent of a powdered caramel color;
providing a mixer;
placing first said wheat starch, next said dextrose, next said powdered caramel color, and then said pregelatinized starch into said mixer;
operating said mixer at a selected speed and for a selected period to mix said dextrose, said wheat starch and pregelatinized starch and said powdered caramel color to form powdered crust colorant;
discharging said powdered crust colorant from said mixture;
providing a frozen unfinished dough product;
applying said crust colorant mixture to said frozen unfinished dough product;
providing an oven; and
finishing said powdered crust colorant mixture and said dough in said oven for a selected period of time at a selected energy level to finish said dough and to color said dough.

18. The method of claim 17 wherein said mixer is a Hobart 140 quart mixer.

19. The method of claim 18 wherein said mixer is operated at a slow speed for a period of about 10 minutes.

20. The method of claim 17 wherein said oven is a microwave oven into which said crust colorant mixture and said unfinished dough are placed and wherein said microwave open is operated at full power for a period of about 1 minute.

21. The method of claim 16 further providing a rotary drum into which said frozen unfinished dough product is placed one after another and into which said powdered crust colorant is metered to coat each of said unfinished dough product.

22. The method of claim 21 wherein said frozen unfinished dough product is a frozen unfinished cinnamon roll.
